(19) United States
(12) Patent Application Publication
(10) Pub. No.: US 2007/0194048 A1
(43) Pub. Date: Aug. 23, 2007

(54) PERSONAL DEFENSE DEVICE

(75) Inventor: MICHAEL TEIG, HEBER CITY, UT (US)

Correspondence Address: ADVANTIA LAW GROUP, 9035 SOUTH 1300 EAST, SUITE 200, SANDY, UT, 84094, US

(73) Assignee: TIGERLIGHT, INC., HEBER CITY, UT (US)

(21) Appl. No.: 11/678,014

(22) Filed: Feb. 22, 2007

Related U.S. Application Data
(60) Provisional application No. 60/776,110, filed on Feb. 22, 2006.

(51) Int. Cl. B65D 5/66; B67D 5/64; B67D 1/07

(52) U.S. Cl. 222/113; 222/175; 222/192

(57) ABSTRACT

A personal defense device for providing illumination and chemical spray protection, comprising: a housing defining a cavity and having a long axis; a fluid canister disposed substantially internal to the cavity; a first actuator device in communication with the fluid canister and configured to release fluid therefrom on actuation; a spray nozzle coupled to the housing and in communication with the fluid canister, the spray nozzle oriented in a direction substantially orthogonal to the long axis of the housing; a power module, disposed substantially internal to the cavity, substantially adjacent to the fluid canister, and oriented substantially parallel to and non-collinearly with the fluid canister; a light system coupled to the housing and substantially disposed within the cavity, the light system oriented to provide light emanating in a direction substantially parallel to the long axis of the housing; and a second actuator device configured to actuate the light system.

### CROSS-REFERENCE TO RELATED APPLICATIONS

This invention claims priority, under 35 U.S.C. § 120, to the U.S. Provisional Patent Application No. 60/776,110, filed on Feb. 22, 2006, which is incorporated by reference herein.

### BACKGROUND OF THE INVENTION

1. Field of the Invention

The present invention relates to systems and devices used for personal defense, specifically to compact, non-lethal systems and devices including lights and chemical sprays.

2. Description of the related art

In the related art, a variety of different types of personal defense systems and devices are often used by law enforcement and non law enforcement persons in defending against and incapacitating potential attackers. In many cases, defending against a personal attack using lethal force is unwise and, indeed, illegal for law enforcement officers and others. Therefore, there exists a great need for non-lethal, yet effective defense devices and systems that can incapacitate and discourage potential attackers; while still remaining simple to use and easy to carry.

Currently there are a variety of non-lethal personal defense devices and system available. While providing some of the necessary components for a non-lethal defense against an attack, such as a chemical spray, sound canister, lighting device, etc., the current defense devices and systems fail in a variety of aspects. For example, in many instances, an individual may accidentally spray an approaching person while attempting to turn on the lighting component. These accidents can have drastic consequences such as lawsuits, fighting and, in the case of law enforcement, reprimands and/or suspensions.

The current systems and devices also fail to include a remedy for many instances where victims and law enforcement officers have difficulty remembering or describing the identity or characteristics of their attackers. Indeed, in many cases, many months after an attack a victim and officer are required to identify and described an attacker.

Additionally, many of the current systems and devices are bulky and complicated and therefore fail to effectively prevent attackers. In many instances, an attacker may be able to see the victim has a device, and therefore prevent the device's use. Additionally, a defense device may be too complicated such that a victim is unable to use the device before an attack occurs. More, a device transported or carried in a victim's purse or bag may be hard to locate and use before an attack occurs.

Some improvements have been made in the personal defense field. Examples include, but are not limited to, the references described below, which references are incorporated by reference herein:

U.S. Pat. No. 5,549,220, issued to Whalen, discloses a non-lethal, graded method for deterring an assailant by using a hand-held self-defense device which includes an electrical storage battery which acts as a power source, a lamp which emits a directed beam of high-intensity white light, a lamp which emits high-intensity diffuse blue light, a siren, and a source of pressurized chemical repellent. First, an intense beam of white light is directed at the eyes of the assailant; then intermittent high-intensity diffuse blue light and high-intensity sound are simultaneously emitted. If these operations prove inadequate to deter the attack, a spray of chemical repellent is discharged at the eyes of the assailant, using the beam of white light as a guide.

U.S. Pat. No. 4,223,804, issued to Morris et al., discloses a portable defense device combining a flashlight with a renewable, interchangeable cylinder containing compressed gas which may be used to generate a noise, to disperse dye and/or an odoriferous spray. The compressed gas may be stored in a canister which may take the form of a spray can having the typical articulated dispensing nozzle which is then received in an articulated throat assembly displaced to release the contents by a pivoted trigger engaging a pivoted arm assembly. In the normal state the trigger is aligned over the exit opening of the throat, thus protecting the dispensing nozzle from inadvertent release, and when released the trigger aligns to engage the arm.

U.S. Pat. No. 5,683,168, issued to Teig, et al., discloses an improved spray canister light comprising a lens cap threadably secured to a light head cap, the light head cap threadably secured to a battery body containing batteries therein. The spray canister light further comprising a canister body threadably secured to the battery body and environmentally sealed therefrom, the canister body including a replaceable canister and a depressible spray nozzle therein. An on/off push action switch contained within the body may be depressed so as to activate the light whereas the depressible spray nozzle within the canister portion may be depressed so as to discharge from the spray canister light the contents of the canister. In the preferred embodiment, the on/off switch and the depressible spray nozzle are recessed with respect to an outer surface of the device.

U.S. Pat. No. 5,795,054, issued to Booty, Jr, discloses a flashlight which is combined with either a pepper spray or a sonic alarm as a defensive device against an attack by either a human or an animal assailant. A secondary light outlet provides an illumination in the direction of the defensive spray or the sonic alarm source which are positioned perpendicular to the primary light source. A sliding collar serves as a protective cover over the actuator button of the spray or alarm. In an emergency, the half-groove, half-rib design of the elliptical shaped handle permits correct orientation of the guardlight by only a tactile sense by the user. A finger-guard on the handle protects the user's hand from protruding into the line of the defensive spray.

U.S. Patent Application Publication No.: 2002/0108,966, by Park, discloses an apparatus disguised as a flashlight to be used as a self protection device. This apparatus includes a housing ergonomically designed to fit a user's hand. Included in the housing are a battery, a low battery indicator device, a lighting device, a chemical spray canister, a shocking primary electrode and an additional shocking electrode, each component having a trigger assembly. The primary electrodes are triggered by a trigger switch. The additional electrode is triggered by applying force on the electrodes. The personal safety device has a safety device that can disable the personal safety device when it is pulled from a user.

The inventions heretofore known suffer from a number of disadvantages, some of which include: being bulky and large; being complicated and not easy to use; having a high risk of unintentionally using a chemical spray on a non-attacker; being difficult to locate quickly and easily; inadequately assisting a victim in identifying attacker; and/or so forth.

What is needed is a personal defense device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available personal defense devices. Accordingly, the present invention has been developed to provide a personal defense device that is compact and light weight which may rest in the palm of a user's hand. The personal defense device also provides an effective, simple to use and locate, effective, and non-lethal defense against attackers. Additionally, the personal defense device was developed to assist a user in not unintentionally spraying an individual. Further, the device assists a user in identifying and recording the identity of an attacker.

In one embodiment, there is a personal defense device for providing illumination and chemical spray protection, potentially comprising: a housing defining a cavity and having a long axis; a fluid canister disposed substantially internal to the cavity, and configured to contain a fluid; a first actuator device in communication with the fluid canister and configured to release fluid therefrom on actuation; a spray nozzle coupled to the housing and in communication with the fluid canister, the spray nozzle oriented in a direction substantially orthogonal to the long axis of the housing; a power module, disposed substantially internal to the cavity, substantially adjacent to the fluid canister, and oriented substantially parallel to and non-collinearly with the fluid canister; a light system coupled to the housing and substantially disposed within the cavity, the light system in communication with the power module and oriented to provide light emanating in a direction substantially parallel to the long axis of the housing; and a second actuator device in communication with the light module, and configured to actuate the light system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a perspective view of a personal defense device according to one embodiment of the invention;

FIG. 2 is an elevational side view of a personal defense device according to one embodiment of the invention;

FIG. 3 is a cross-sectional side view of a personal defense device according to one embodiment of the invention;

FIG. 4 is a cross-sectional side view of a personal defense device according to one embodiment of the invention;

FIG. 5 is a front elevational view of a personal defense device according to one embodiment of the invention;

FIG. 6 is a bottom plan view of a personal defense device according to one embodiment of the invention;

FIG. 7 is a block diagram of a personal defense device according to one embodiment of the invention;

FIG. 8 is a side elevational view of operation of a light system of a personal defense device according to one embodiment of the invention;

FIG. 9 is a perspective view of an operation of a spray canister of a personal defense device according to one embodiment of the invention;

FIG. 10 is a perspective view of a personal defense device, according to one embodiment of the invention; and

FIG. 11 is block diagram of a personal defense system according to one embodiment of the invention.

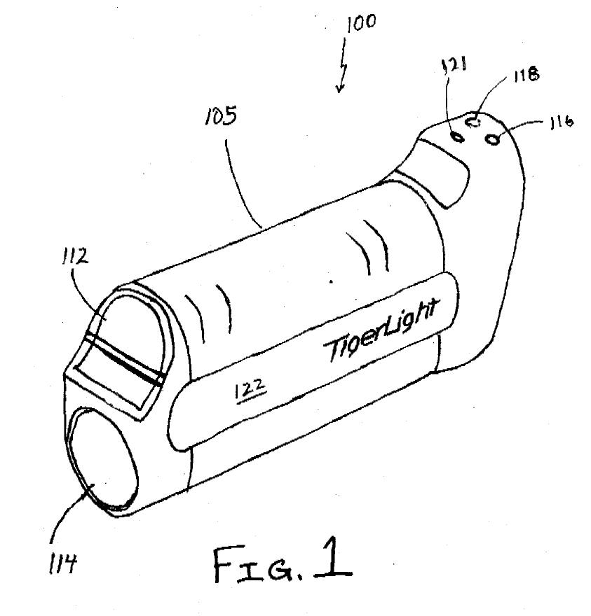

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Further, it should be noted that the present invention may employ any number of conventional techniques for data transmission, signaling, data processing, network control, and the like. Still further, the invention may be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

Additionally, many of the functional units and/or modules herein are described as being “in communication” with other functional units and/or modules. Being “in communication” refers to any manner and/or way in which functional units and/or modules, such as, but not limited to, batteries, cameras, computers, laptop computers, PDAs, modules, spray tops, buttons, actuators, levers, and/or other types of hardware and/or software, may be in communication with each other. Some non-limiting examples include communicating, sending, and/or receiving data and metadata via: fluid, pressure, mechanical levers, circuitry, electrical and magnetic fields and/or pulses, a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like.

As shown generally throughout the figures, there is a personal defense device 100 for providing illumination and chemical spray protection, comprising: a housing 105 or main body 105 defining a cavity 330 and having a longitudinal axis 215; a fluid canister 304 disposed substantially internal to the cavity 330, and configured to contain a fluid; a first actuator device 335 in communication with the fluid canister 304, which is configured to release fluid therefrom on actuation; a spray nozzle 326 that is coupled to the housing 105 and in communication with the fluid canister 304. A power module 306 is disposed substantially internal to the cavity 330, substantially adjacent to the fluid canister 304, and oriented substantially parallel to and non-collinearly with the fluid canister 304. A light system 340 is coupled to the housing 105 and substantially disposed within the cavity 330. The housing 105 may be any variety of shapes and/or sizes and may be composed of any type and/or kind of material contemplated in the art. Some non-limiting examples of material include: plastic, polyurethane, ceramic, metal, aluminum, and/or so forth. In a non-limiting example, the housing 105 is sized such that the housing would rest comfortably in a person's palm.

Additionally, as shown generally throughout the figures, the housing or main body 105 is formed and/or includes an ergonomic design resembling that of a pistol grip or handle. The housing 105 may include any ergonomic designs and features contemplated in the art. In a non-limiting example, the housing includes one or more gripping portions 206 sized and formed to fit a person's fingers and hand. The housing 105 may include regions encased by a material suitable to enhance a person's grip on the housing 105. Some non-limiting examples of gripping material include: rubber, soft rubber, bumps, and/or so forth.

Also shown throughout the figures, the housing 105 may include and/or define a cavity 330. The cavity 330 may function to contain and/or protect the various components of the personal defense device 100 and may be any size or shape contemplated in the art. In a non-limiting example, the cavity 330 may be embodied in one or more smaller cavities 330 which may function to separate and/or encloses one or more components of the personal defense device 100.

Still, as shown throughout the figures, the personal defense device 100 includes a fluid canister 304 disposed substantially internal to the cavity 330, and configured to contain a fluid. In being disposed substantially internal to the cavity 330, the fluid canister 304 may or may not be completely encased by and/or contained in the cavity 330. Also, being substantially encased by the cavity 330 may be defined as the fluid canister being sixty percent to ninety percent encased by and/or contained in the cavity 330. The fluid canister 304 may be any type of fluid canister 304 and/or contain any type of fluid contemplated in the self defense art. In a non-limiting example, the canister 304 is a spray canister containing a fluid capable of inhibiting an attacking person, such as, but not limited to: pepper spray, mace, carbon disulfide, teargas, and/or so forth. The spray may be embodied in a pressurized and/or non-pressurized container.

Also shown throughout the figures, the personal defense device 100 includes a spray nozzle 326 that is in communication with the fluid canister 304. The spray nozzle 326 may be any type and/or kind of spray nozzle contemplated in the art. In a non-limiting example, the spray nozzle 326 may be coupled to the exterior of the housing 105 and in communication with the fluid canister 304 through a tubular member 120, to allow the chemical to escape from the interior of the fluid canister 304. The tubular member 120 extends toward and contact the orifice 121 located at the end of the tubular member 120. The spray nozzle 326 may be adjustable by a user to spray a fluid in a steady stream or in a mist.

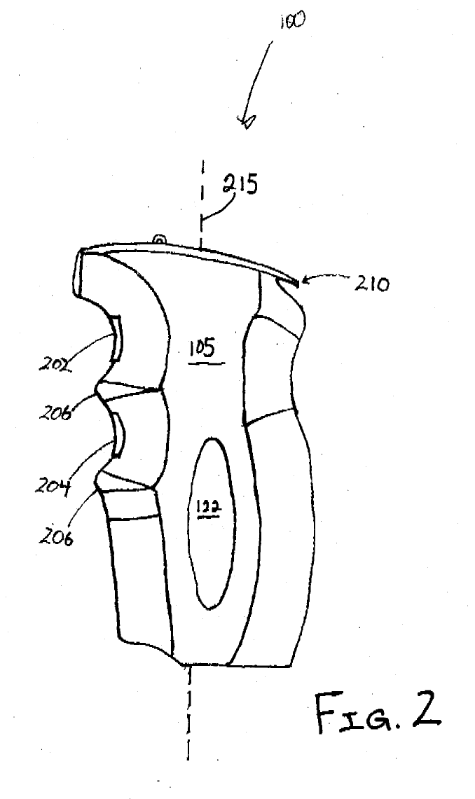

As illustrated in FIGS. 2, 3, and 9 at least the spray nozzle 326 and the tubular member 120 are oriented in a direction substantially orthogonal to the long axis 215 of the housing 105. The longitudinal axis 215, being generally defined as extending longitudinally from the top portion 345 of the personal defense device 100 to the bottom light portion thereof as shown in FIG. 2. In being oriented substantially orthogonal to the long axis, the spray nozzle 326 and tubular member 120 may or may not be exactly orthogonal to the long axis 215. Additionally, the spray nozzle 326 and tubular member 120 may be oriented at angles slightly greater than or slightly less than ninety degrees, such as but not limited to sixty-five to eighty five degrees or one hundred to one hundred twenty degrees. Further, orienting the spray nozzle 326 and the elongated tubular member 120 functions to direct the spray trajectory 910 of the chemical or other noxious spray in a direction substantially orthogonal to the long axis 215.

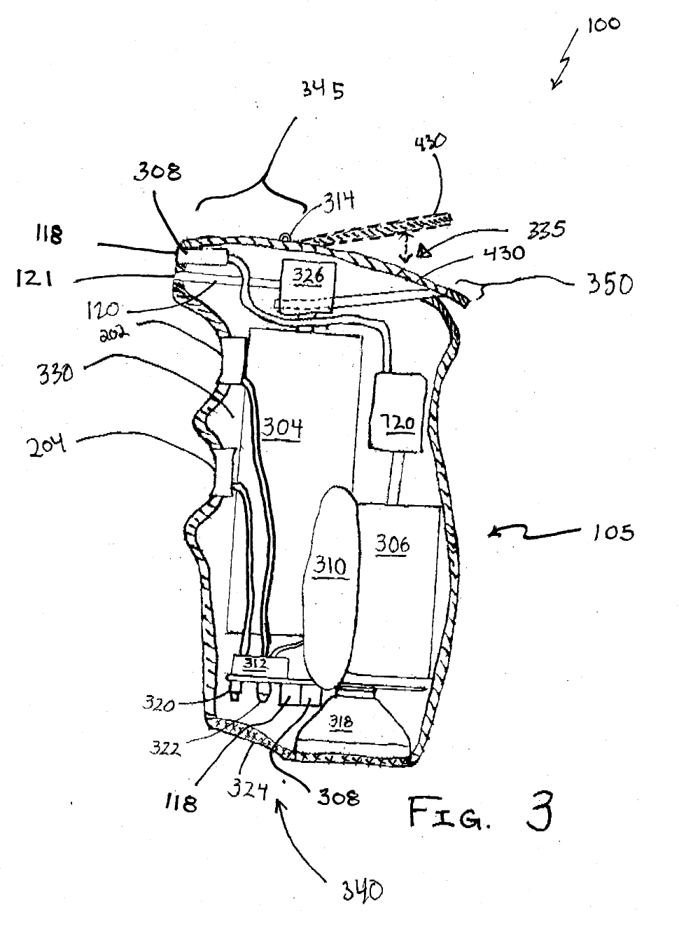

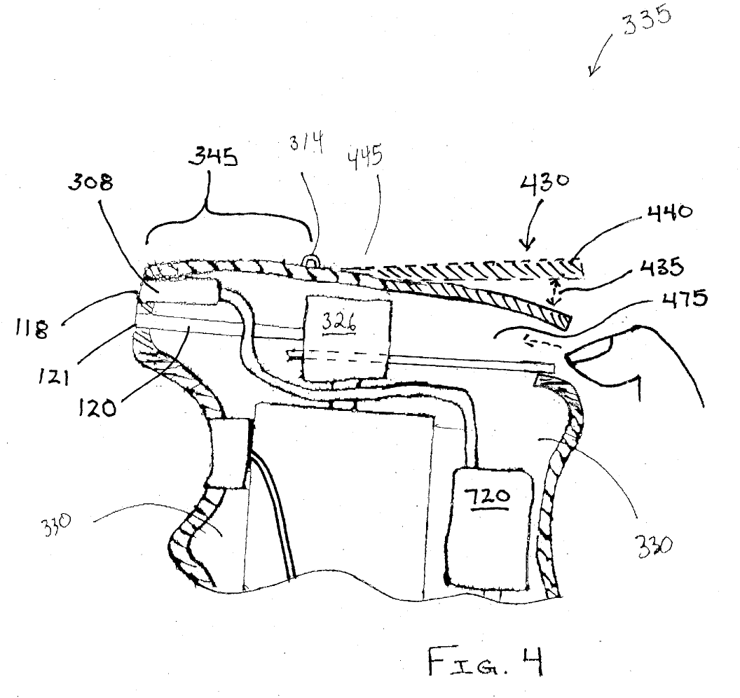

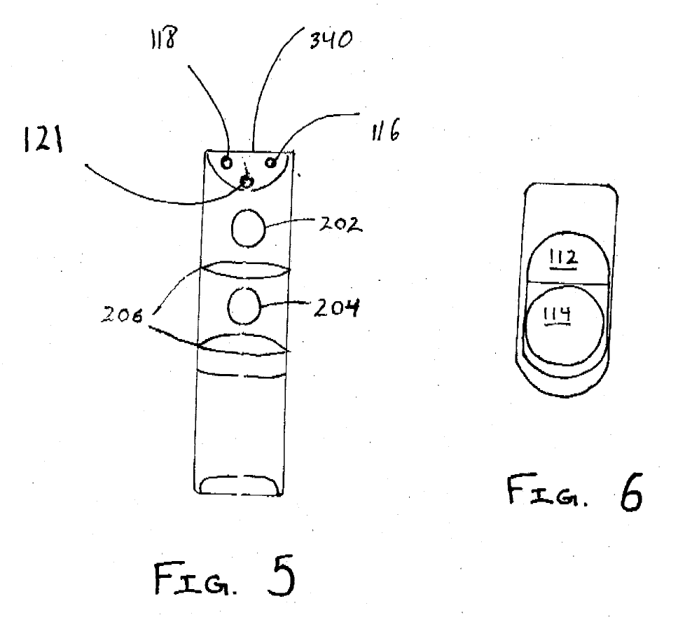

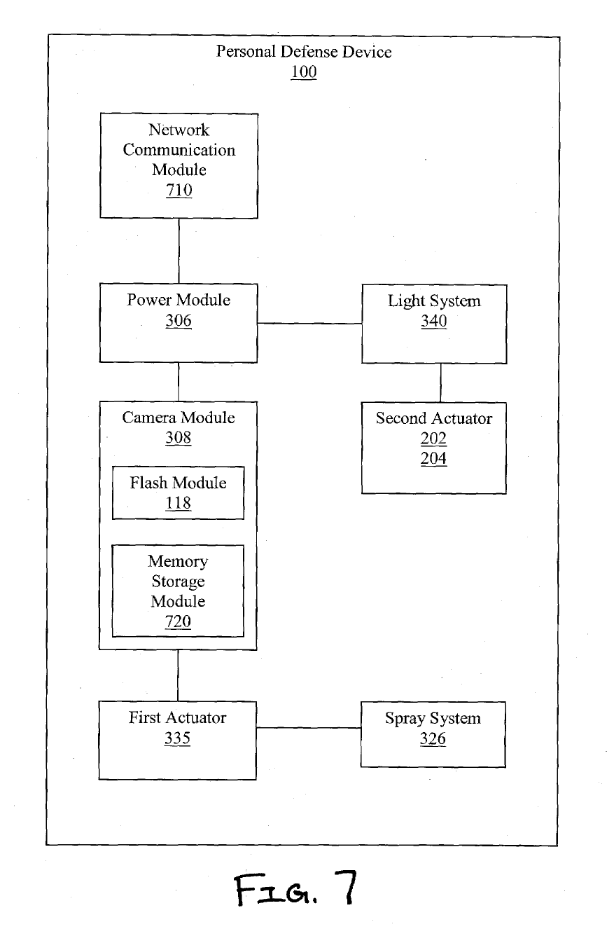

As shown in FIGS. 3 and 4, the personal defense device 100 includes a first actuator device 335 in communication with the fluid canister 304 and configured to release fluid therefrom upon actuation. The first actuator device 335 may be any type of actuator device contemplated in the art, such as but not limited to: levers, mechanical levers, buttons, switches, electronic circuits, pressure induced switches, and/or so forth. In an non-limiting example, the first actuator device 335 comprises a first elongated member 430 or cap, that is pivotally coupled to a top portion 345, such that a user may pivotally open the housing 105; thereby, exposing the spray nozzle 326 for activation by enabling a thumb of a user to contact the nozzle 326 or second elongated member 470. Disposed between the first elongated member 430 and the second elongated member 470 there may be an opening or gap 475. The opening 475 may function to allow a user to slide his or her thumb or finger into the opening; thereby gaining access to the spray second elongated member 470 or substantially planar member 470.

As further shown in FIGS. 3 and 4, the first elongated member 430 or cap includes an end portion 445, pivotally coupled to the top portion 345 of the personal defense device 100 such that the first elongated member 430 may pivot upwards 435; thus opening the top of the housing 105. The opposing end portion 440 of the first elongated member 430 may extend slightly outward such that an extrusion or lip 350 is formed; thereby assisting a user in flipping and/or pivoting the first elongated member 430 by the user's thumb and thereby opening the top of the housing 105.

In an additional embodiment, the top of the housing 105 may include a securing system coupled to the top of the housing 105, configured to the removably secure the first elongated member 430 to the housing 105 in closed position. The securing system may include any components and/or be configured in any manner contemplated in the art. In a non-limiting example, the securing system may be pair of opposing rubber or plastic tabs inwardly coupled to top of the housing 105 where the first elongated member 430 may be disposed. In operation, to flip open the first elongated member 430 a user merely needs to apply upward pressure, thereby pivoting the first elongate member 430 upward. Advantageously, to operate the first actuator device 335, a user simply needs to slide his or her thumb through the opening 475 or gap 475 up the first elongated member 430, and apply downward pressure on the second elongated 470 or substantially planar 470 member, which in turn applies downward pressure on the spray nozzle 326 and/or head 326.

In additional embodiment, as shown in FIGS. 3 and 4, the first actuator device 335 may also include a second elongated member 470 or substantially planar member 470 coupled to the housing 105 extending through the cavity 330 and oriented substantially orthogonal to the longitudinal axis 215 of the cavity 330 and the housing 105. Being oriented substantially orthogonal may be defined as previously described. The second elongated member 470 may include an end portion 475 extending through or above the spray nozzle head 326 toward the front of the personal defense device 100. Being substantially planar, the second elongated member 470 may or may not be one hundred eight degrees. Rather, the second elongated member may be planar enough such that a person may apply enough downward force on the second elongated member as to cause ejection of the fluid in the canister 304. The opposing end portion extends toward the rear end portion 440 of the first elongated member 430. In an additional embodiment, the second elongated member 470 extends adjacent to the spray nozzle 326, the spray nozzle and/or head 326 including a tab member 460. The second elongated member 470 may rest on top of and/or be coupled to the tab member 460.

In one embodiment, the first and second elongated members 430, 470 may be composed of any material and/or comprise any additional components contemplated in the art. Some non-limiting examples include: plastic, rubber, ceramic, polyurethane, and/or so forth. In a non-limiting example, the first and/or second elongated members 430, 470 include rubber and/or serrated portions to enable better gripping and more convenient function.

Advantageously, in operation, the first actuator device 335 is easy and simple to operate. A user merely flips the first elongated member 430 upwards with their thumb by contacting the extension 350, thereby opening the housing 105 and exposing the second elongated member 470. Applying downward pressure on the second elongated member 470 communicates and/or applies downward pressure on the spray nozzle 326 which, in turn releases the fluid from the fluid canister 304, through the tube 120 and out the orifice 121.

Additionally, as illustrated throughout the figures, the personal defense device 100 includes a power module 306. The power module 306 is disposed substantially internal to the cavity 330, substantially adjacent to the fluid canister 304, and oriented substantially parallel to and noncollinearly with the fluid canister 304. In being disposed substantially internal to the cavity 330, the power module 306 may or may not be completely encased and/or contained in the cavity 330 as previously described. In being substantially adjacent to and being oriented substantially parallel to and non-collinearly with the fluid canister 304, the power module 306 may or may not be juxtaposed exactly next to the fluid canister 304. Indeed, the power module 306 may be oriented juxtaposed such that the top and/or bottom of the power module 306 or the fluid canister 304 are not aligned in any particular order. The power module 306 may be any type and or kind of power module contemplated in the art. Some non-limiting examples of power modules 306 may include: any type of battery such as, but not limited to, 9 volt, lithium ion, AAA, AA, C, D, etc; any type of solar cell, solar powered power source, and/or so forth. The power module 306 is configured to provide energy and power to the components of the personal defense device 100.

As shown in the appropriate figures, the personal defense device 100 comprises a light system 340 coupled to the housing 105 and typically substantially disposed within the cavity 330, and being in communication with the power module 306 in any know conventional manner. Being substantially disposed within the cavity 330 may be defined as previously described. The light system 340 may be oriented to provide light emanating in a light trajectory 810 generally parallel to the long axis 215 of the housing 105. In being generally parallel to the long axis 215, the light trajectory 810 may or may not be exactly parallel to the long axis 215. Indeed, the light trajectory 810 may emanate in a wide angle of plus or minus twenty degrees or more above and below the parallel axis.

Also illustrated in the figures, the light system 340 may include one or more light bulbs, switches, circuits, and may include a variety of light intensities which may have a variety of functional attributes. There may be one or more lights 310, 320, 322, 318 which may configured to emit normal light in one mode and a high intensity beam light in another mode. The high intensity beam light may function to cause temporary blindness or obscured vision on a potential attacker. A first light intensity and/or the second light intensity may comprise a variety of colors and/or shades of light, such as, but not limited to: white light, blue light, red light, and/or so forth.

In an additional embodiment, as shown in the figures, the light system 340 may include one or more light modules 310, 318, 320, 322 which may function to emit strobe, incandescent, and/or fluorescent light. In a non-limiting example, the light system 340, may be internally disposed in the housing 105 and emit light from the device 100 through lenses or other transparent portions 324, 112, 114, 122 of the housing 105.

Also, as shown in the figures, the light system 340 may include a first light module 310 in communication with the power module 306, and configured to substantially illuminate the housing 105. In substantially illuminating the housing 105, the first light module 310 may or may not illuminate the entire housing 105. In a non-limiting example, the first light module 310 may be configured to light a small portion of the housing 105, which includes a transparent region 122, such as but not limited to the logo, the ergonomic grips, etc. Illuminating the housing 105 may function to enable a user to quickly locate and retrieve the personal defense device 100 to prevent an attack. The first light module 310 may comprise a low energy, incandescent, and/or fluorescent light; such that the first light module 310 may be left on for longer periods and not drain power from the power module 306.

In an additional embodiment, the light system 340 may include one or more infrared light sources and/or modules. The one or more infrared lights sources and/or modules may be embodied in and/or comprise any components contemplated in the art.

Additionally, as shown in the figures, the personal defense device 100 may include a second actuator device 202, 204 in communication with the light system 340, and configured to actuate the light system 340. The second actuator device 202, 204 may be any type of actuator device contemplated in the art, such as but not limited to: levers, mechanical levers, buttons, switches, electronic circuits, pressure induced switches, and/or so forth. In a non-limiting example, the second actuator device 202, 204 includes one or more triggers or buttons 202, 204 disposed on the housing. The one or more buttons 202, 204 may be disposed and/or oriented anywhere on the housing 105. In one embodiment, the one or more triggers 202, 204 are included as part of the ergonomic grips of the housing 105, disposed where a user's fingers might be located when gripping the housing 105. In this manner, a user can quickly and easily actuate and control the various functions of the light system 340 without actuating the spray mechanism 335.

In one embodiment, the second actuator device 202, 204 functions to actuate and/or control the modes and/or intensities of the lights. In a non-limiting example, the top trigger 202 may actuate the normal and high intensity light modules and the bottom trigger 204 may actuate the strobe and/or incandescent light modules 720. Additionally, the top and bottom triggers 202, 204 may be configured to cooperatively actuate the one or more lights 310, 318, 320, and/or 322. In a non-limiting example, a user may press the top trigger 202 causing actuation of the normal light. To quickly actuate the high intensity beam light, for example, a user simply needs to additionally press the bottom trigger 204. Further, the second actuator device 202, 204 may be configured such that a user may press the top or bottom triggers 202, 204 repeated times to cycle through the various light modules and/or modes as previously described.

As demonstrated by the various figures, the personal defense device 100 also may include a camera module 308 configured to capture a photo and/or a video. The camera module 308 may comprise a lens 118, and a storage module 720 configured to store and/or record photos and video captured by the camera module 308 and/or lens 118. The camera module 308 may be any type and/or kind of camera module contemplated in art. In a non-limiting example, the camera module 308 is similar to those currently available in cells phones and other personal digital assistants (PDAs).

As shown in the figures, the camera module 308 and lens are disposed adjacent to the spray nozzle 121 and the camera module 308 may be oriented in a substantially parallel direction as the spray trajectory 910. Being substantially parallel may be defined as previously described herein. Being oriented in a similar or parallel trajectory to the spray, the camera module 308 may function to quickly and easily allow photos and/or video images to be captured and/or recorded of a potential attacker. In an alternative embodiment, the camera module 308 may be disposed apart from the spray nozzle, which may function to prevent the spray mist from interfering with photo and/or video images. In a non-limiting example, the camera module 308 may be disposed and/or coupled to the top portion 340 of the housing 105 such that when a user flips open the top portion 340 to access the spray nozzle 120, 326, the camera module 308 is oriented substantially parallel to the spray trajectory 910 to take pictures of items being sprayed.

Also, as illustrated in FIG. 3, the camera module 308 and/or flash module 118 may be mounted on adjacent to and/or near the one or more lights 310, 318, 320, and/or 322. The camera module 308 and/or flash module 118 may be oriented substantially parallel to the light trajectory 810; thereby enabling a user to capture photo and video images while using the lights 310, 318, 320, and/or 322.

Also shown in the figures, the camera module 308 is in communication with the first actuator device 335, such that approximately the same moment that a user actuates the first actuator device 335, or spray, the camera module 308 is actuated and a photo or video image is captured. In being actuated at approximately the same moment, the camera module may or may not be actuated simultaneous with the first actuator device 335. Indeed, actuation of the camera module 308 may occur one or two seconds or milliseconds after activation of the first actuator device 335. This delayed actuation may function to get a clearer image of the attacker. Actuating the camera module 308 substantially simultaneously with actuation of the first actuator device 335 may be accomplished by any means, components, and/or function contemplated in the art. Some non-limiting examples include sensors and/or switches communicating the camera module 308 with the first actuator device 335. In a simple non-limiting example, a sensor and/or switch on the camera module 308 may be disposed beneath and/or coupled to the spray nozzle 326, such that downward pressure on the spray nozzle 326 causes activation of the switch and/or sensor.

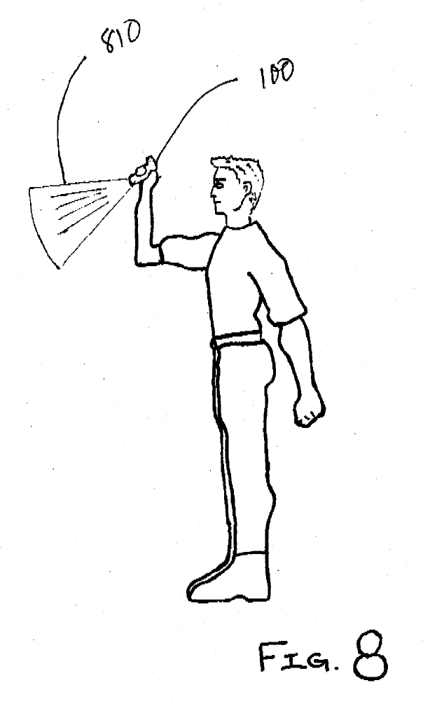

As illustrated in FIGS. 7 and 11, the personal defense device 100 includes a network communication module 710 in communication with the power module 306, and configured to communicate the personal defense device 100 with a network 930. The network communication module 710 may additionally be in communication with the camera module 308 and be configured to be able to download and/or send photo and/or video images over a network 930 to a computer for example. The network communication module 710 may function to communicate the personal defense device 100 with police networks 920, emergency services networks 920, and/or family or close contacts networks 920. The network communication module 710 may be any type and/or kind of network communication module contemplated in the art.

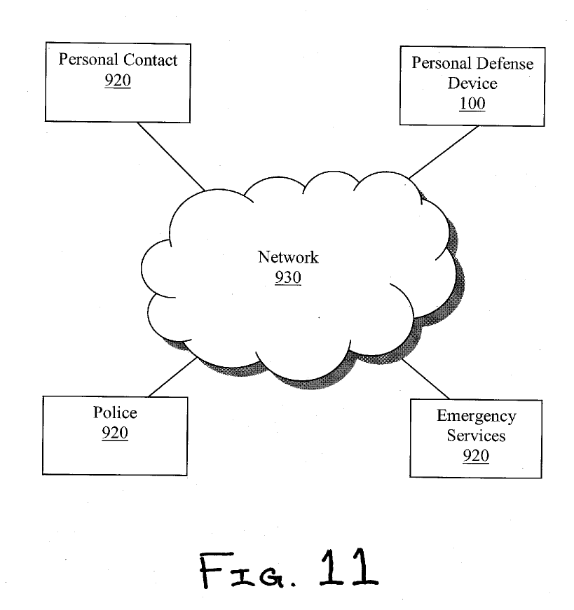

Additionally, as shown in FIG. 10, the personal defense device 100 includes an anchoring system 940. The anchoring system 940 may be any type and/or kind of anchoring device contemplated in the art, such as but not limited to, wrist straps, cords, bands, etc. In a non-limiting example, the wrist anchoring system 940 includes: a substantially elastic member 945 having one end coupled to the housing 105 and the opposing end being removably couplable to an anchoring member 950. The substantially elastic member 945 may be coupled to the housing 105 in any manner and/or orientation contemplated in the art.

As shown in FIG. 10, the substantially elastic member 945 is coupled at one or more positions on the on the gripping portion of the housing 105 substantially adjacent to where a user's palm might rest. The substantially elastic member 945 may be any type and/or kind of elastic member contemplated in the art. In being substantially elastic, the elastic member 945 may have varying degrees of elasticity and/or tension. Indeed, the substantially elastic member 945 may also include an adjustment mechanism, which may function to adjust the length of the substantially elastic member 945. With the adjustment mechanism, the anchoring system may be adaptable for a variety of different users, having different hand and/or wrist lengths, and/or users w/ varying degrees of hand strength. In alternative embodiment, the substantially elastic member 945 may be made to constrict and/or retract into and/or adjacent to the first coupling mechanism 955 and/or anchoring member 950.

Also shown in FIG. 10, the anchoring system 940 may include an anchoring member 950. The anchoring member 950 may be configured to wrap around a user's wrist or arm. The anchoring member 950 may include a first coupling mechanism 955 sized to receive and removably couple to the substantially elastic member 945. The anchoring band 950 may be composed of any material contemplated in the art, such as but not limited to, plastic, steel, polyurethane, cloth, fabric, rubber, etc.

In an alternative embodiment, the anchoring system 940 substantially elastic member may include second coupling mechanism configured to removably adapt and/or couple the substantially elastic member 945 to a user's watch, wristband, or other piece of everyday wrist or arm accessories. A person skilled in the art would realize there are a multitude ways in which to removably couple the substantially elastic member 945 to everyday wrist or arm accessories. Indeed, in a non-limiting example, the substantially elastic member 945 may hook and/or loop into and/or around links or the band of a user's watch. Advantageously, while wearing the anchoring system 940, to gain access and/or operation of the personal defense device 100, a user merely need to swing his or her hand and/or arm in a forward motion such that the personal defense device 100 is swung toward a user's hand, thereby allowing quick and easy access to the personal defense device 100.

As shown in FIG. 3, the personal defense device 100 includes one or more control modules 312. The one or more control modules 312 may be in communication with the various components and/or modules of the personal defense device 100 and may function to control and/or coordinate the various components, as described herein. One skilled in the art would realize there are a variety of ways to construct and/or configure the one or more control modules and/or circuit boards 312.

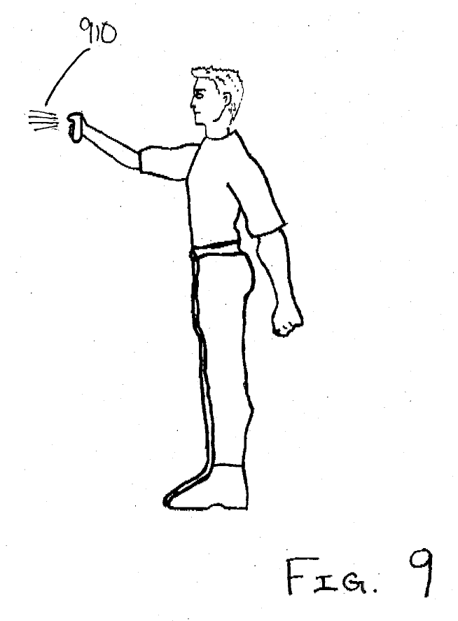

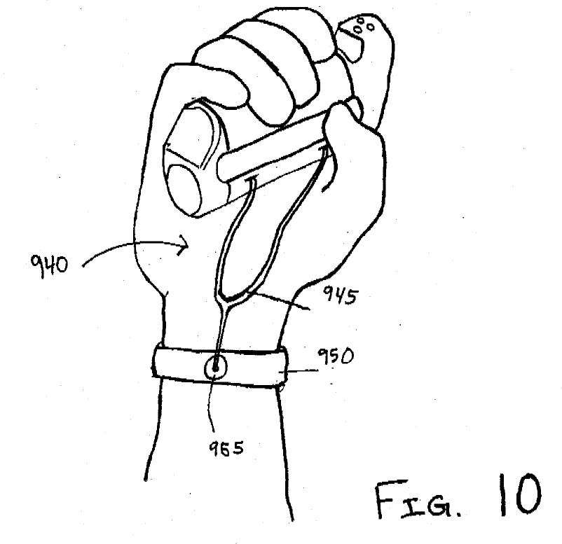

Also shown in the figures, the operation of the personal defense device 100 is simple and easy to use, enabling a user to quickly locate the personal defense device 100, and quickly and effectively use the personal defense device 100 to deter and/or incapacitate a potential attacker. For example, if a user spots a suspicious looking person, or potential attacker, the user may quickly locate the personal defense device 100 in a purse or bag due to the lamination of the housing 105. A user may then actuate the first normal light and/or high intensity beam light by raising his or her arm, thus enabling him or her to better view and/or scare away the potential attacker. If a potential attacker does not back away or continues to approach, the user simply needs to adjust the orientation of the personal defense device 100 and spray the oncoming attacker. Advantageously, as shown in FIGS. 8 and 9, the light trajectory 810 and the spray trajectory 910 being substantially orthogonal to each other assists in preventing a person and/or law enforcement agent from unintentionally spraying individuals. Alternatively, if a user is traveling at night or in an otherwise high crime area, he or she may want to use the anchoring system 940, thereby anchoring the personal defense device 100 against his or her wrist for quick and easier access.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

It is envisioned the personal defense device 100 may comprise and/or may be substantially encased in a holder and/or casing. The casing and/or holder may include an attachment mechanism coupled to thereto and attachable to and/or adaptable to a person's body, clothes, belt, and/or the personal accessories. Indeed, the attachment mechanism may be coupled to the housing 150 or main body 105, such a user may directly attach the personal defense device 100 to his or her person.

Although FIG. 10 illustrates the substantially elastic member 945 removably coupling at one location on the anchoring member 950, it is understood the substantially elastic member 945 may include a plurality coupling location and/or points on the anchoring member 950. Indeed, the substantially elastic member 945 need not be removably coupled, but rather permanent coupled to the anchoring member 950.

Additionally, although FIGS. 3 and 4 illustrate the second elongated and/or substantially planar member 470 to extend through or along the sides of the spray nozzle 326, it is envisioned the second elongated and/or substantially planar member 470 may extend adjacent to and/or directly contact the top portion of the spray nozzle 326.

It is expected that there could be numerous variations of the design of this invention. A non-limiting examples includes the ergonomic features of the housing 105 may be embodied in and/or vary in any manner contemplated in the art. The gripping portions 206 may be configured and/or disposed on any portion of the device 100 such that comfort and ease of action are maximized.

Finally, it is envisioned that the components of the device may be constructed of a variety of materials. Some non-limiting examples of materials include: plastic, rubber, wiring, steel, crystal, polyurethane, and/or so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A personal defense device for providing illumination and chemical spray protection, comprising:
a housing defining a cavity and having a long axis;
a fluid canister disposed substantially internal to the cavity, and configured to contain a fluid;
a first actuator device in communication with the fluid canister and configured to release fluid therefrom on actuation;
a spray nozzle coupled to the housing and in communication with the fluid canister, the spray nozzle oriented in a direction substantially orthogonal to the long axis of the housing;
a power module, disposed substantially internal to the cavity, substantially adjacent to the fluid canister, and oriented substantially parallel to and non-collinearly with the fluid canister;
a light system coupled to the housing and substantially disposed within the cavity, the light system in communication with the power module and oriented to provide light emanating in a direction substantially parallel to the longitudinal axis of the housing; and
a second actuator device in communication with the light module, and configured to actuate the light system.

2. The personal defense device of claim 1, further comprising a camera module in communication with the power module, coupled to the housing, and configured to capture photo and video.

3. The personal defense device of claim 2, wherein the camera module is in communication with the first actuator device.

4. The personal defense device of claim 1, wherein the light emanating in a direction substantially parallel to the longitudinal axis of the housing comprises a high intensity beam light.

5. The personal defense device of claim 5, wherein the light emanating in a direction substantially parallel to the longitudinal axis of the housing comprises normal light.

6. The personal defense device of claim 1, wherein the housing further comprises:
a substantially transparent region; and
a light module disposed substantially adjacent to the substantially transparent region, the light module in communication with the power module, and configured to illuminate the personal defense device.

7. The personal defense device of claim 1, further comprising a network communication module coupled to the housing, in communication with the power module, and configured to communicate with a network.

8. A personal defense device comprising:
a substantially hollow main body;
a fluid canister disposed substantially internal to the main body, and configured to contain a fluid, the fluid canister including:
a first actuator device; and
a spray trajectory;
a power module, disposed substantially internal to the main body, and configured to provide energy to the personal defense device;
a light system in communication with the power module, and configured to provide light, the light system including:
a light module;
a second actuator device in communication with the light module, and configured to actuate the light system; and
a light trajectory;
wherein the fluid canister and the power module are aligned substantially parallel, adjacent, and non collinear, and wherein the spray trajectory is substantially orthogonal to the light trajectory; and
a wrist anchoring system coupled to the main body, and configured to anchor the main body to a person's wrist.

9. The personal defense device of claim 8, wherein the spray is substantially orthogonal to the main body and the light trajectory is substantially parallel to the longitudinal axis of the main body.

10. The personal defense device of claim 8, further comprise a camera module in communication with the power module, coupled to the main body, and configured to capture photo and video.

11. The personal defense device of claim 10, wherein the camera module is in communication with the first actuator device.

12. The personal defense device of claim 9, wherein the light system further comprises a first mode, wherein the light module is configured to emit a high intensity beam light.

13. The personal defense device of claim 9, wherein the light system further comprises a second mode, wherein the light module is configured to emit normal light.

14. The personal defense device of claim 8, wherein the light system further comprises a second light module in communication with the power module, and configured to illuminate the personal defense device.

15. The personal defense device of claim 8, further comprising a network communication module coupled to the main body, in communication with the power module, and configured to communicate with a network.

16. The personal defense device of claim 8, wherein the wrist anchoring system further comprises:
an anchoring member, and
a substantially elastic member having a first end coupled to the main body and a second end removably coupled to the anchoring member.

17. A personal defense device comprising:
a housing defining a cavity and having a long axis;
a fluid canister disposed substantially internal to the cavity, and configured to contain a fluid;
a first actuator device in communication with the fluid canister and configured to release fluid therefrom on actuation;
a spray nozzle coupled to the housing and in communication with the fluid canister, the spray nozzle oriented in a direction substantially orthogonal to the long axis of the housing;
a power module, disposed substantially internal to the cavity, substantially adjacent to the fluid canister, and oriented substantially parallel to and non-collinearly with the fluid canister;
a light system coupled to the housing and substantially disposed within the cavity, the light system in communication with the power module and oriented to provide light emanating in a direction substantially parallel to the longitudinal axis of the housing;
a second actuator device in communication with the light module, and configured to actuate the light system;
a camera module coupled to the housing, the camera module in communication with the power module, and configured to take capture photo and video; and
a wrist anchoring system coupled to the housing.

18. The personal defense device of claim 17, wherein the camera module is in communication with the first actuator device.

19. The personal defense device of claim 17, further comprising a network communication module coupled to the housing, the network communication module in communication with the power module and configured communicate with a network.

20. The personal defense device of claim 17, wherein the wrist anchoring system further comprises:
an anchoring member, configured to wrap around person's wrist; and
a substantially elastic member having a first end coupled to the main body and a second end coupled to the anchoring member.
